(19) United States
(12) Patent Application Publication
(10) Pub. No.: US 2018/0132158 A1
(43) Pub. Date: May 10, 2018

(54) Uplink-Assisted Mobility Procedure In Millimeter Wave Communication Systems

(71) Applicant: MediaTek Inc., Hsinchu City (TW)

(72) Inventors: Li-Chuan Tseng, Hsinchu City (TW); Chia-Chun Hsu, Hsinchu City (TW)

(21) Appl. No.: 15/801,306

(22) Filed: Nov. 1, 2017

Related U.S. Application Data
(60) Provisional application No. 62/417,390, filed on Nov. 4, 2016.

(51) Int. Cl. H04W 36/38; H04W 36/00; H04W 76/04

(52) U.S. Cl. CPC H04W 36/385; H04W 36/0088; H04W 72/1263; H04W 76/046; H04W 36/0083

(57) ABSTRACT

Concepts and examples pertaining to uplink-assisted mobility procedure in millimeter wave (mmWave) communication systems are described. A user equipment (UE) may receive an uplink (UL) signaling configuration from a source base station (BS) of a wireless network. The UE may periodically transmit a UL reference signal, which are measured by the source BS, in response to receiving the UL signaling configuration. The UE may receive a handover command from the source BS. The UE may also perform a handover procedure with a target BS in response to receiving the handover command from the source BS.

### CROSS REFERENCE TO RELATED PATENT APPLICATION(S)

The present disclosure claims the priority benefit of U.S. Provisional Patent Application No. 62/417,390, filed 4 Nov. 2016, the content of which is incorporated by reference in its entirety.

### TECHNICAL FIELD

The present disclosure is generally related to wireless communications and, more particularly, to uplink-assisted mobility procedure in millimeter wave (mmWave) communication systems.

### BACKGROUND

Unless otherwise indicated herein, approaches described in this section are not prior art to the claims listed below and are not admitted as prior art by inclusion in this section.

In mmWave wireless communication systems, which operate at higher frequency (HF) bands, larger bandwidth and higher throughput can be achieved. Due to high carrier frequency, the coverage of a transmission-reception point (TRP) is small. Beam-forming, which provides high antenna gain, is a key enabling technology to compensate the propagation loss due to higher carrier frequency. However, one major concern regarding mmWave system is the increased complexity and power consumption with respect to neighbor cell measurement for mobility procedures, since there are multiple beams to be measured for each cell. Performing less frequent neighbor cell measurement may help reduce power consumption, but this may lead to degraded mobility performance.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An alternative to current downlink-based mobility procedure is the so-called uplink-based mobility procedure. An objective of the present disclosure is to propose a novel uplink-assisted mobility procedure or scheme to improve the mobility performance for user equipment (UE) in mmWave systems. Advantageously, the proposed procedure or scheme may reduce UE power consumption while maintaining an acceptable handover performance.

In one aspect, a method may involve a processor of a UE receiving an uplink (UL) signaling configuration from a source base station (BS) of a wireless network. The method may also involve the processor periodically transmitting a UL reference signal, which are measured by the source BS, responsive to receiving the UL signaling configuration. The method may further involve the processor receiving a handover command from the source BS. The method may additionally involve the processor performing a handover procedure with a target BS responsive to receiving the handover command from the source BS.

In one aspect, a method may involve a processor of a source BS transmitting an UL signaling configuration to a UE of a wireless network. The method may also involve the processor measuring a UL reference signal periodically transmitted by the UE. The method may further involve the processor determining to trigger a handover procedure to hand over the UE to a target BS based at least in part on a result of the measuring. The method may additionally involve the processor transmitting a handover command to the UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a message flow under a legacy downlink-based handover procedure and a message flow under an uplink-assisted handover procedure in accordance with an implementation of the present disclosure.

FIG. 2 is a diagram of a concept of adaptive measurement reporting in accordance with an implementation of the present disclosure.

FIG. 3 is a diagram of an example system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

The 3GPP Technical Specification (TS) 36.331 describes current LTE handover procedures, including measurement event reporting and message exchanges related to handover. However, the handover procedure in the 3GPP LTE specification does not consider cells with multiple beams. An intuitive modification is to represent each cell with the strongest beam, and operate the handover procedure using a parameter (e.g., reference signal received power (RSRP)) of the strongest beam of each cell. A problem of this approach, however, is the high rate of cell-level Ping-Pong (performing handover of a UE from a source eNB of a serving cell to a target eNB of a neighboring cell and back soon) due to improper handover decisions. The Ping-Pong events can be mitigated by adopting a more conservative handover strategy such as using a higher triggering offset. However, this may lead to higher handover failure rate since the handover may be delayed and the handover command cannot be delivered to the UE from the source eNB.

Under the proposed procedure in accordance with the present disclosure, an intuitive way to improve handover decision-making involves allowing the UE to take into account the signal strength of more than one beam when evaluating the serving and neighboring cells. The proposed procedure is herein interchangeably referred as “N-best cell comparison”, since the proposed procedure considers N best beams (e.g., those with highest RSRP) of serving and neighbor cells for comparison. Under the proposed procedure, there may be different ways to compare two cells when additional beams are considered.

More specifically, under the proposed procedure in accordance with the present disclosure, a number of problems may be addressed. For instance, under the proposed procedure in accordance with the present disclosure, service interruption due to cell-level Ping-Pong effect may be reduced as the proposed procedure is inherently robust. That is, observing more beams under the proposed procedure may barely result in slightly more failures, overhead or consumption of battery power.

To enable the proposed procedure in accordance with the present disclosure in the context of mmWave communication systems, a number of essential details may be proposed. In particular, an adaptive model to determine whether to consider beams other than the strongest one may be proposed. Additionally, a method of cell comparison when more than one beam is considered may be proposed. Moreover, a definition of corresponding measurement events may be proposed.

It is noteworthy that the language used herein is mostly defined in the referenced 3GPP technical specifications. Certain terms are highlighted below.

The notation “cell” is herein intended to include embodiments where the existing cell concept of Long-Term Evolution (LTE) is preserved and enhanced to a more flexible definition, with scalable coverage, deployment as well as functions. More specifically, a cell may contain any number ranging from one to hundreds of transmission-reception points (TRPs), resulting in a scalable cell size. Single TRP in one cell may be more aligned to current concept of cell, except for the consideration on beam-specific operation. On the other hand, for a cell that consists of multiple TRPs, the TRPs may be connected to a central unit via ideal front-haul.

The notation “handover” is used herein to denote an existing mobility procedure for connected mode, where signaling is performed both in source and target cells. To align with the refined “cell” notation, the behavior that a UE switches between TRPs in a (multi-TRP) cell is not considered as handover. Handover Procedure in mm Wave Systems with Uplink Assistance

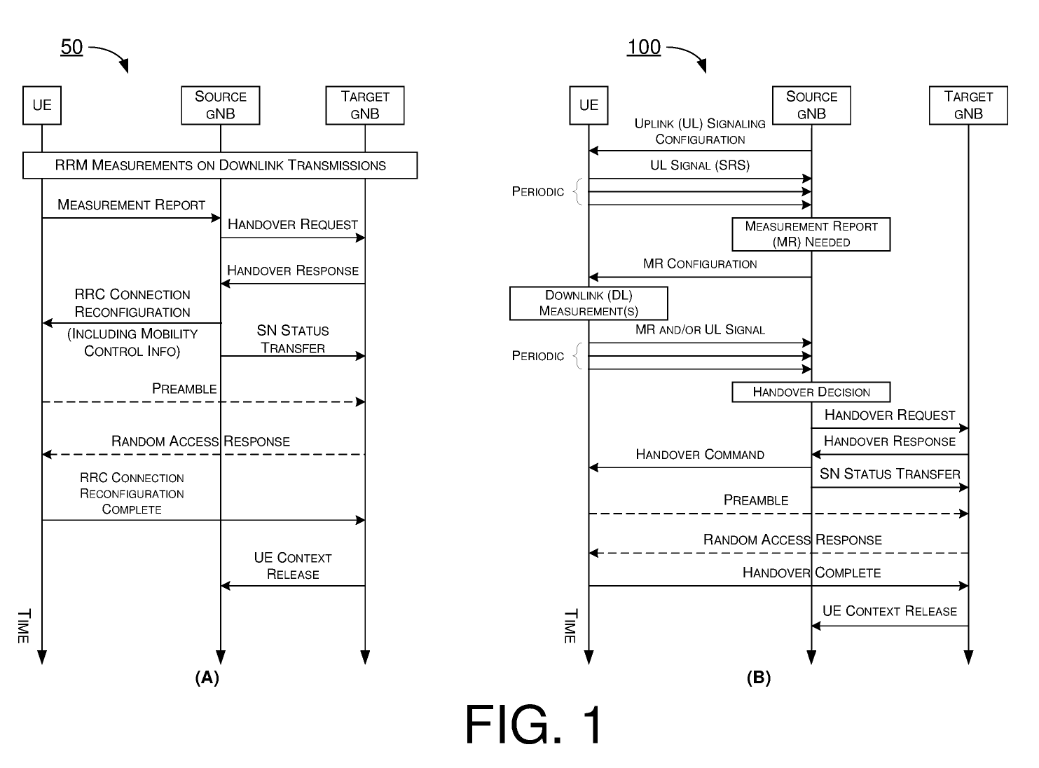

FIG. 1 illustrates a message flow under a legacy downlink-based handover procedure 50 and a message flow under an uplink-assisted handover procedure 100 in accordance with an implementation of the present disclosure. Referring to part (A) of FIG. 1, under the legacy downlink-based handover procedure 50, radio resource management (RRM) measurements are performed by a UE on downlink transmissions from at least a source gNB and a target gNB. The UE transmits a measurement report to the source gNB. Based on the measurement report, the source gNB decides to trigger a handover procedure. Accordingly, the source gNB transmits a handover request to the target gNB. The target gNB transmits a handover response to the source gNB to indicate acceptance of the handover request. The source gNB then transmits a radio resource control (RRC) connection reconfiguration (including mobility control information) to the UE, as a handover command. The source gNB also transmits a sequence number (SN) status transfer to the target gNB. For handover, the UE transmits a preamble to the target gNB, which in turn transmits a random-access response to the UE. The UE then transmits a RRC connection reconfiguration complete message to the target gNB to complete the handover procedure. The target gNB also transmits a UE context release to the source gNB. It is noteworthy that the notions “source gNB” and “serving gNB” are used interchangeably herein, with the understanding that before completion of a handover procedure the source gNB is the serving gNB (and the target gNB is the serving gNB after completion of the handover procedure).

Under the uplink-assisted handover procedure 100 in accordance with the present disclosure, the UE may transmit periodic uplink signals used to assist downlink-based handover decision made by a source base station or source gNB. The mechanism under the proposed procedure may include a number of enabling elements, including: (1) configuration and transmission of periodic uplink signals, (2) adaptive downlink measurement control based on uplink signals, (3) early handover preparation based on uplink signals, and (4) UE-centric handover decision based on adaptive measurement in downlink transmissions.

Referring to part (B) of FIG. 1, in the context of mmWave communication systems, the uplink-assisted handover procedure 100 may be divided into a number of major steps or stages. Firstly, a source gNB may transmit uplink signaling configuration to a UE, including parameters for periodic uplink signal transmission such as, for example and without limitation, UE-specific signal format and transmission period. Secondly, the UE may transmit periodic uplink signals, which may be measured by the source gNB. The UE may or may not perform downlink measurements at this stage. Thirdly, when the source gNB finds downlink measurement results to be necessary (e.g., when uplink RSRP falls below a first pre-configured threshold), the source gNB may transmit measurement report configuration to the UE to indicate parameters such as, for example and without limitation, reporting object, period and duration. Fourthly, the UE may report downlink measurement results (e.g., as periodic measurement reports) accordingly, including information such as, for example and without limitation, identification (ID) of the best cell, the RSRP of source cell, and the RSRP of the best neighbor cell. The UE may also transmit uplink signals periodically according to previous configuration. The periods of measurement report and uplink signaling may be identical or different. Fifthly, when the source gNB finds a handover to be necessary (e.g., when uplink signal strength falls below a second pre-configured threshold) while the source gNB has not yet received an event-driven measurement report, the source gNB may transmit a handover request to a target gNB via X2. Next, the target gNB may transmit a handover response to the source gNB in an event that the handover request is accepted by the target gNB. Subsequently, the source gNB may transmit a handover command to the UE, which indicates or otherwise identifies the target gNB. Then, the UE may perform random access to the assigned target gNB and complete the handover procedure.

It is noteworthy that even with uplink measurement(s), the handover may still be a downlink-based mobility procedure. Therefore, the UL signal sent by a UE is only measured by the serving cell, not by any neighbor cell, and thus the UE may still need to perform an event-driven measurement reporting procedure (e.g., an A3 event for intra-frequency handover).

### Measurement on Uplink Reference Signal

With respect to measurement on uplink reference signal, the UE may transmit an uplink reference signal according to the configuration received from the source gNB. The configuration may include information such as, for example and without limitation: (1) UE-specific reference signal or a sequence number in an event that the reference signal is drawn from a set of sequences, (2) transmission interval, which is an interval between two consecutive uplink signal transmissions, and (3) transmission duration, as the UE may stop after performing uplink signal transmissions for a certain duration or after a predetermined number of uplink reference signals having been transmitted. It is noteworthy that the UE may transmit less frequently or no uplink reference signal in an event that the signal strength from the source gNB is above a given threshold (e.g., similar to S-criteria). Regarding the format of uplink reference signal, the uplink reference signal for handover assistance may be defined in a UE-specific manner so that each UE may have a unique ID within its serving NR cell. The uplink reference signal of different UEs may be transmitted in different time-frequency resources or, alternatively, using different orthogonal codes, and therefore may be identified by the gNB. Moreover, in an event that the UE is capable of beamforming, the UE may choose the beam for transmitting the uplink reference signal.

### Periodic Reporting of Downlink Measurements

With respect to periodic reporting of downlink measurements, comparison of two cells may become more complicated when multiple beams are considered for one or both cells. Accordingly, the present disclosure also proposes a scheme of multi-beam cell evaluation. Under the proposed scheme, it is assumed that the beam RSRP at point C (e.g., after layer-3 filtering) of the serving cell (herein denoted as “servingRSRP_C”) and a neighbor cell (herein denoted as “neighborRSRP_C”) may be sorted in a descending order, respectively. The measurement report may be triggered when a number of conditions are satisfied for a given duration (e.g., time-to-trigger or “TTT”). In an NR network, a cell may have multiple beams. To reduce the amount of reporting overhead, some consolidation on the measurements may be needed.

Under a proposed scheme, the measurement reporting configuration may include information such as, for example and without limitation: (1) content of measurement report, which may indicate about which and how many cells the UE should report (e.g., serving cell, best neighbor cell and the like), measurement consolidation method (e.g., best beam, average of N-best beams and so forth), and cell quality indicator (e.g., RSRP, reference signal received quality (RSRQ), and signal-to-interference and noise ratio (SINR)) and the like), (2) reporting interval, which may be an interval between two consecutive transmissions of the periodic measurement reports, and (3) reporting duration, as the UE may stop measurement reporting after transmitting the report for a given number of duration of time or after a predetermined number of periodic measurement reports having been transmitted.

Under the proposed scheme, serving gNB may configure or reconfigure the measurement reporting due to one or more triggering conditions. For example, a triggering condition may be that the uplink signal strength (e.g., RSRP and/or RSRQ) falling below a pre-configured threshold. As another example, a triggering condition may be that the uplink signal strength (e.g., RSRP and/or RSRQ) dropping faster than a pre-configured rate (e.g., measured in dB/ms) for a given duration.

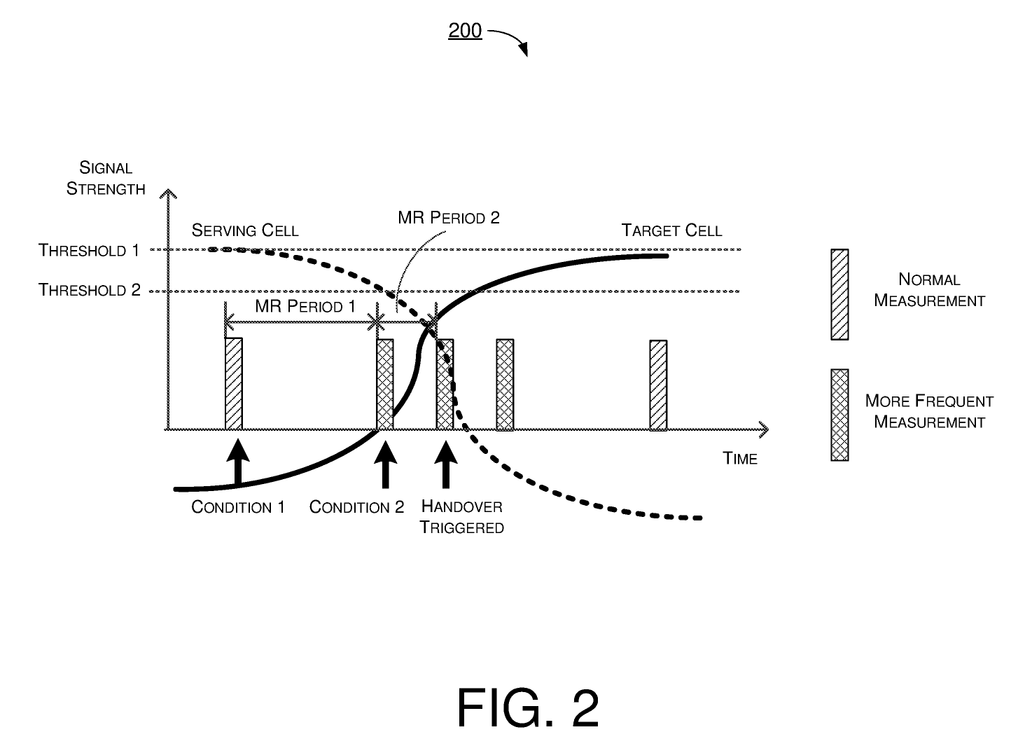

Under the proposed scheme, the serving gNB may adjust the measurement configuration adaptively based on uplink measurement results. For example, when uplink signal strength falls below a threshold, a relatively sparse measurement reporting may be configured. Then, when the uplink signal strength falls below an even lower threshold, the gNB may transmit another configuration to cause the UE to report downlink measurement results. FIG. 2 illustrates a concept of adaptive measurement reporting in accordance with an implementation of the present disclosure.

Handover Triggering based on Uplink Measurements

With respect to handover triggering based on uplink measurements, with uplink assistance configured, a serving gNB may transmit a handover request to a target gNB (e.g., via X2) to prepare the target gNB for the upcoming handover of a UE when the serving gNB determines that handover is needed while the serving gNB has not yet received an event-driven measurement report. Specifically, the serving gNB may detect a need of handover when either or both of the following conditions exists: (1) the uplink signal strength (e.g., RSRP and/or RSRQ) remaining below a pre-configured threshold for a given amount of duration, and (2) the uplink signal strength (e.g., RSRP and/or RSRQ) falling below an even lower pre-configured threshold.

Under the proposed scheme, the target cell may be selected by the serving gNB based on any of a number of methods, depending on the information provided in the measurement report content. For example, the serving gNB may select the cell with the highest best-beam RSRP/RSRQ. Alternatively, the serving gNB may select the cell with the highest N-best-beam average RSRP/RSRQ. Still alternatively, the serving gNB may select the cell with the longest TTT timer value among a number of cells whose corresponding TTT timers are running.

Under the proposed scheme, the serving gNB may receive an event-driven measurement report from the UE (e.g., due to TTT timeout) while waiting for handover response from the target gNB. In such case, the serving gNB may either ignore the event-driven measurement report or accept the target gNB derived from the report.

Under the proposed scheme, when the serving gNB receives a positive response from the target gNB regarding the handover request, the serving gNB may transmit a handover command to the UE. Correspondingly, the UE may stop any running TTT timer upon receiving the handover command. Moreover, assistance based on uplink measurements may be suspended, and it may be resumed after the handover procedure is completed.

It is noteworthy that, in the context of LTE, upon handover failure (HoF), the UE may perform radio resource control (RRC) reestablishment. Similarly, in an event that a handover triggered by uplink measurement fails, RRC reestablishment may be used for connection recovery.

### Illustrative Implementations

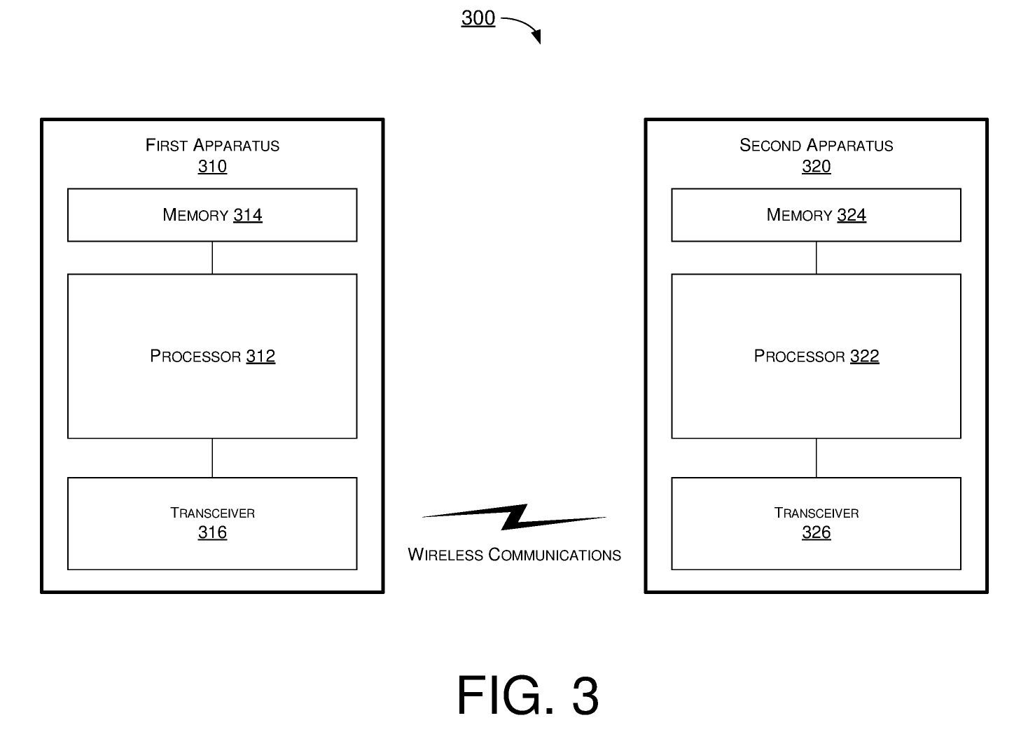

FIG. 3 illustrates an example system 300 having at least an example apparatus 310 and an example apparatus 320 in accordance with an implementation of the present disclosure. System 300 may be a part of an mmWave system. Each of apparatus 310 and apparatus 320 may perform various functions to implement schemes, techniques, processes and methods described herein pertaining to uplink-assisted mobility procedure in mmWave communication systems, including the various schemes and procedures described above with respect to FIG. 1 and FIG. 2 described above as well as processes 400 and 500 described below.

Each of apparatus 310 and apparatus 320 may be a part of an electronic apparatus, which may be a base station (BS) or a UE, such as a portable or mobile apparatus, a wearable apparatus, a wireless communication apparatus or a computing apparatus. For instance, each of apparatus 310 and apparatus 320 may be implemented in a smartphone, a smartwatch, a personal digital assistant, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a wire communication apparatus or a computing apparatus. For instance, each of apparatus 310 and apparatus 320 may be implemented in a smart thermostat, a smart fridge, a smart door lock, a wireless speaker or a home control center. When implemented in or as a BS, apparatus 310 and/or apparatus 320 may be implemented in an eNodeB (eNB) in a LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1 and FIG. 2, each of apparatus 310 and apparatus 320 may be implemented in or as a BS or a UE. Each of apparatus 310 and apparatus 320 may include at least some of those components shown in FIG. 3 such as a processor 312 and a processor 320, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to uplink-assisted mobility procedure in mmWave communication systems in accordance with various implementations of the present disclosure.

In some implementations, apparatus 310 may also include a transceiver 316 coupled to processor 312. Transceiver 316 may be capable of wirelessly transmitting and receiving data. In some implementations, apparatus 320 may also include a transceiver 326 coupled to processor 322. Transceiver 326 may include a transceiver capable of wirelessly transmitting and receiving data.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

In accordance with the present disclosure, a method of enabling mobility in mmWave systems may involve each of apparatus 310 and apparatus 320 performing various operations. For illustrative purposes and without limiting scope of the present disclosure, the following description of functionality and capability of apparatus 310 and apparatus 320 is provided in the context of apparatus 310 functioning as a UE and apparatus 320 functioning as a source BS. The method of enabling mobility in mmWave systems may involve the following: (1) apparatus 320, as a serving gNB, transmitting to apparatus 310, as a UE, an uplink (UL) signaling configuration which contains parameters for the periodic uplink signal transmission such as, for example and without limitation, UE-specific signal format and transmission period; (2) apparatus 310, as a UE, periodically transmitting an uplink reference signal which is measured by the serving gNB, and apparatus 310 may or may not be performing downlink (DL) measurements at this stage; (3) in response to apparatus 320 determining that downlink measurement results are needed (e.g., when uplink RSRP falls below some threshold), apparatus 320 transmitting a measurement report configuration to apparatus 310 to indicate parameters such as, for example and without limitation, reporting object, period and duration; (4) apparatus 310 periodically reporting downlink measurement results (e.g., periodic measurement report) accordingly, including information such as, for example and without limitation, identification (ID) of the best cell and the RSRP of the serving cell as well as the best neighbor cell, and apparatus 320 may also transmit the uplink reference signal periodically according to previous configurations (with a periodicity of the DL measurement report and a periodicity of the UL reference signal being the same or different from each other); (5) in response to apparatus 320 determining that a handover is needed (e.g., uplink signal strength falls below another pre-configured threshold) but an event-driven measurement report has not yet been received, apparatus 320 transmitting a handover request to a target gNB (e.g., via Xn interface); (6) the target gNB transmitting a handover response to apparatus 320 in an event that the request is accepted; (7) apparatus 320 transmitting a handover command to apparatus 310, with the handover command indicating the target gNB; and (8) apparatus 310 performing random access to the assigned target to complete the handover.

In some implementations, the uplink signaling configuration may carry information about the UE-specific reference signal, transmission interval, and transmission duration.

In some implementations, the uplink reference signal for handover assistance may be defined in a UE-specific manner so that each UE of a plurality of UEs in the serving NR cell has a unique ID within the serving NR cell.

In some implementations, the uplink reference signals of different UEs may be transmitted in different time-frequency resources, or using different orthogonal codes, and therefore can be identified by apparatus 320.

In some implementations, apparatus 310 may transmit less frequently or no uplink reference signal in an event that its signal strength from apparatus 320 is above a pre-configured threshold.

In some implementations, apparatus 320 may configure or reconfigure the measurement reporting due to one or more triggering conditions, including: (1) the uplink signal strength (RSRP/RSRQ) falls below a pre-configured threshold; and (2) the uplink signal strength (RSRP/RSRQ) drops faster than a pre-configured rate (e.g., dB/ms) for a given duration.

In some implementations, the measurement reporting configuration may include information on content of measurement report such as, for example and without limitation: which and how many cells apparatus 310 should report (serving cell, best neighbor cell, etc.), measurement consolidation method (best beam, average of N-best beams, etc.), cell quality indicator (RSRP, RSRQ, SINR, etc.). The measurement reporting configuration may also include information on reporting interval, which is the interval between two reports of the periodic measurement reports. The measurement reporting configuration may further include information on reporting duration such that apparatus 310 may stop measurement reporting when it has been sending the report for a given time duration or it has sent a given number of periodic measurement reports.

In some implementations, apparatus 320 may adjust the measurement configuration adaptively based on uplink measurement results. For example, when uplink signal strength falls below a threshold, a relatively sparse measurement reporting is configured. Subsequently, when the uplink signal strength falls below an even lower threshold, apparatus 320 may send another configuration to make apparatus 310 report downlink measurement results.

In some implementations, when apparatus 320 determines that a handover is needed while it has not yet received the event-driven measurement report, apparatus 320 may transmit a handover request to the target gNB via X2 (e.g., to prepare the target gNB for the upcoming handover).

In some implementations, apparatus 320 may detect the need of handover in one of a number of ways including, for example and without limitation: (1) the uplink signal strength (RSRP/RSRQ) remaining below a pre-configured threshold for a given time duration; (2) the uplink signal strength (RSRP/RSRQ) falling below an even lower pre-configured threshold.

In some implementations, a target cell may be selected by apparatus 320, depending on the information provided in the measurement report content, based on one or more methods including, for example and without limitation: (1) selecting the cell with highest best-beam RSRP/RSRQ; (2) selecting the cell with highest N-best-beam average RSRP/RSRQ; and (3) selecting the cell with the longest TTT timer value among the cells whose corresponding TTT timers are running.

In some implementations, apparatus 320, when receiving an event-driven measurement report from apparatus 320 while waiting for the handover response (from target gNB), may either: (1) ignore the event-driven measurement report, or (2) accept the target gNB derived from the report.

In some implementations, apparatus 320 may transmit a handover command to apparatus 310 in an event that a positive response is received from the target gNB. Afterwards, apparatus 310 may stop any running TTT timer upon receiving a handover command. Moreover, the assistance based on uplink measurement(s) may be suspended, and may be resumed after the handover procedure is completed.

In some implementations, in response to receiving a negative response from the target gNB, apparatus 320 may choose another target gNB based on latest measurement reports.

In some implementations, in an event that the handover triggered by uplink measurement fails, apparatus 310 may perform RRC reestablishment, which may be the same as in other handover failure cases.

### Illustrative Processes

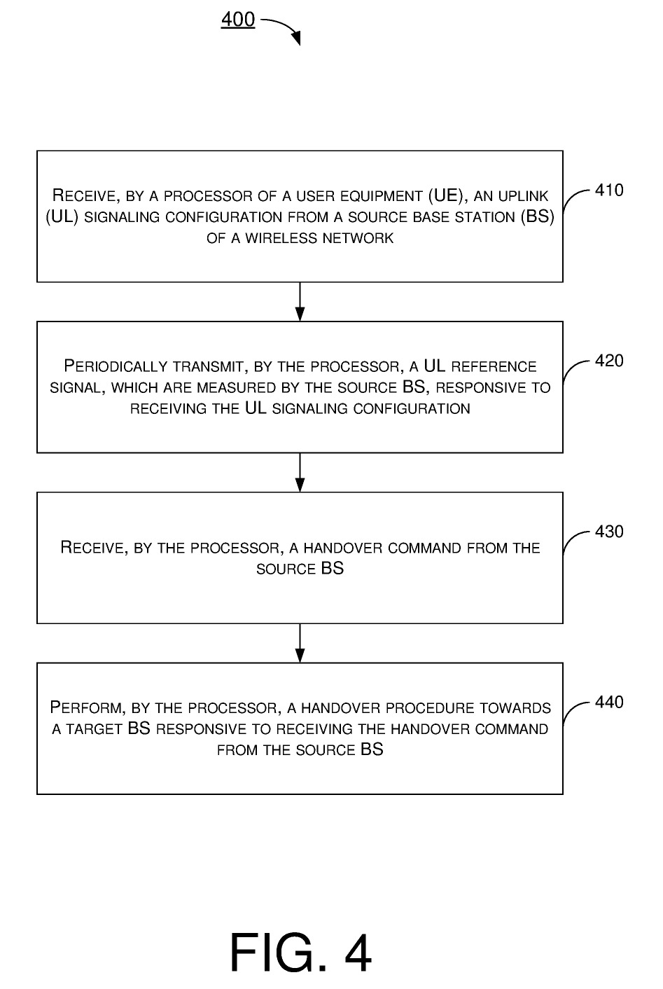

FIG. 4 illustrates an example process 400 in accordance with an implementation of the present disclosure. Process 400 may represent an aspect of implementing the proposed concepts and schemes such as one or more of the various schemes and procedures described above with respect to FIG. 1-FIG. 3. More specifically, process 400 may represent an aspect of the proposed concepts, schemes and procedures pertaining to uplink-assisted mobility procedure in mmWave communication systems. For instance, process 400 may be an example implementation, whether partially or completely, of the proposed schemes and procedures described above for uplink-assisted mobility procedure in mmWave communication systems. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. The blocks/sub-blocks of process 400 may be executed iteratively. Process 400 may be implemented by or in apparatus 310 and/or apparatus 320 as well as any variations thereof. Solely for illustrative purposes and without limiting the scope, process 400 is described below in the context of apparatus 310 functioning as a UE and apparatus 320 functioning as a source BS. Process 400 may begin at block 410.

At 410, process 400 may involve processor 312 of apparatus 310, as a UE of a wireless network, receiving via transceiver 316 a UL signaling configuration from apparatus 320, as a source BS, of the wireless network. Process 400 may proceed from 410 to 420.

At 420, process 400 may involve processor 312 periodically transmitting, via transceiver 316, a UL reference signal, which are measured by apparatus 320, responsive to receiving the UL signaling configuration. Process 400 may proceed from 420 to 430.

At 430, process 400 may involve processor 312 receiving, via transceiver 316, a handover command from apparatus 320. Process 400 may proceed from 430 to 440.

At 440, process 400 may involve processor 312 performing a handover procedure with a target BS responsive to receiving the handover command from apparatus 320.

In some implementations, the UL signaling configuration may include one or more parameters for the transmitting of the periodic UL signals. The one or more parameters may include information about the UL reference signal, a periodicity for periodically transmitting the UL reference signal, and a duration for transmitting the periodic UL signals.

In some implementations, in periodically transmitting the UL reference signal, process 400 may involve processor 312 transmitting no UL reference signal responsive to a signal strength from apparatus 320 being above a pre-configured threshold.

In some implementations, the UL reference signal may contain a unique identifier (ID) for apparatus 310 within a serving cell of apparatus 310 such that each of a plurality of UEs within the serving cell is respectively associated with a unique ID different from that of another UE of the plurality of UEs.

In some implementations, in periodically transmitting the UL reference signal, process 400 may involve processor 312 transmitting, via transceiver 316, the UL reference signal in time-frequency resources and using orthogonal codes that are different from those associated with another UE of the plurality of UEs.

In some implementations, prior to the receiving of the handover command, process 400 may also involve processor 312 receiving, via transceiver 316, a downlink (DL) measurement report configuration from apparatus 320. Moreover, process 400 may involve processor 312, in response to receiving the DL measurement report configuration, performing operations including: (1) performing DL measurements; and (2) periodically transmitting to apparatus 320 a DL measurement report indicating a result of the DL measurement.

In some implementations, the DL measurement report configuration may include one or more parameters for the DL measurements. The one or more parameters may include a reporting object, a periodicity for periodically transmitting the measurement report, and a duration for performing the DL measurements.

In some implementations, the DL measurement report may include an identification of a best cell and a RSRP of a serving cell and a best neighbor cell.

In some implementations, a periodicity for periodically transmitting the UL reference signal and a periodicity for periodically transmitting the measurement report may be different.

In some implementations, process 400 may further involve processor 312 stopping a time-to-trigger (TTT) timer in response to receiving the handover command.

In some implementations, process 400 may further involve processor 312 performing radio resource control (RRC) reestablishment when the handover procedure is triggered by a failure of uplink measurement.

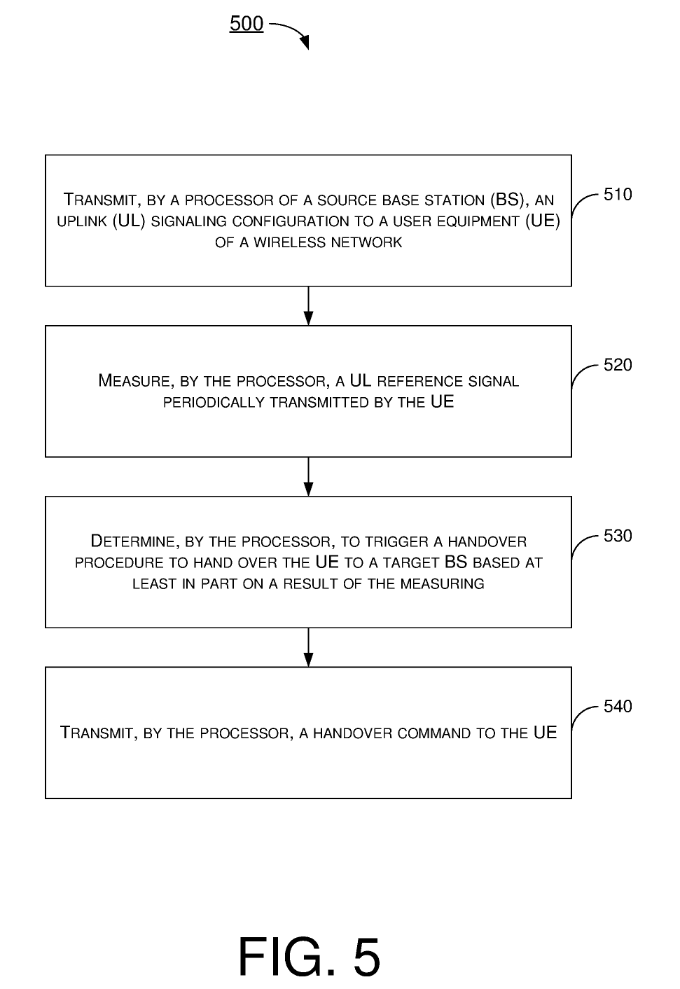

FIG. 5 illustrates an example process 500 in accordance with an implementation of the present disclosure. Process 500 may represent an aspect of implementing the proposed concepts and schemes such as one or more of the various schemes and procedures described above with respect to FIG. 1-FIG. 3. More specifically, process 500 may represent an aspect of the proposed concepts, schemes and procedures pertaining to uplink-assisted mobility procedure in mmWave communication systems. For instance, process 500 may be an example implementation, whether partially or completely, of the proposed schemes and procedures described above for uplink-assisted mobility procedure in mmWave communication systems. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. The blocks/sub-blocks of process 500 may be executed iteratively. Process 500 may be implemented by or in apparatus 310 and/or apparatus 320 as well as any variations thereof. Solely for illustrative purposes and without limiting the scope, process 500 is described below in the context of apparatus 310 functioning as a UE and apparatus 320 functioning as a source BS. Process 500 may begin at block 510.

At 510, process 500 may involve processor 322 of apparatus 320, as a source BS of a wireless network, transmitting via transceiver 326 a UL signaling configuration to apparatus 310, as a UE, of the wireless network. Process 500 may proceed from 510 to 520.

At 520, process 500 may involve processor 322 measuring a UL reference signal periodically transmitted by apparatus 310. Process 500 may proceed from 520 to 530.

At 530, process 500 may involve processor 322 determining to trigger a handover procedure to hand over apparatus 310 to a target BS based at least in part on a result of the measuring. Process 500 may proceed from 520 to 530.

At 530, process 500 may involve processor 322 transmitting, via transceiver 326, a handover command to apparatus 310.

In some implementations, prior to determining to trigger the handover procedure, process 500 may also involve processor 322 transmitting, via transceiver 326, a DL measurement report configuration to the UE. Moreover, process 500 may involve processor 322 periodically receiving, via transceiver 326, a DL measurement report from apparatus 310. Furthermore, process 500 may involve processor 322 performing configuration or reconfiguration of measurement reporting responsive to occurrence of either or both of a plurality of conditions including: (1) an uplink signal strength, represented by a RSRP or a RSRQ, falling below a pre-configured threshold; and (2) the uplink signal strength dropping faster than a pre-configured rate for a predetermined duration.

In some implementations, the DL measurement report configuration may include: (1) a content indicating about which and how many cells apparatus 310 is to report, a measurement consolidation method, and a cell quality indicator; (2) a reporting interval between two consecutive transmissions of the DL measurement report; and (3) a reporting duration represented by a period of time during which apparatus 310 is to periodically transmit the DL measurement report or a predetermined number of periodic transmissions of the DL measurement report.

In some implementations, process 500 may also involve processor 322 adjusting the DL measurement report configuration based on a result of the measuring of the UL reference signal periodically transmitted by apparatus 310 in response to a signal strength of the UL reference signal falling below a threshold.

In some implementations, prior to transmitting the handover command to apparatus 310, process 500 may also involve processor 322 determining a need to trigger the handover procedure while no event-driven measurement report has been received. Additionally, process 500 may involve processor 322 transmitting, via transceiver 326, a handover request to a target BS.

In some implementations, process 500 may also involve processor 322 receiving, via transceiver 326, a negative response from the target BS regarding the handover request. Moreover, process 500 may involve processor 322 selecting another target BS based on one or more measurement reports.

In some implementations, process 500 may involve processor 322 determining the need to trigger the handover procedure in response to either or both of: (1) an uplink signal strength, represented by a RSRP or a RSRQ, remaining below a first pre-configured threshold for a predetermined duration; and (2) the uplink signal strength falling below a second pre-configured threshold which is lower than the first pre-configured threshold.

In some implementations, process 500 may also involve processor 322 selecting the target BS by any of the following: (1) selecting a cell with a highest RSRP or RSRQ among a plurality of cells; (2) selecting a cell with a highest N-best-beam average RSRP or RSRQ among the plurality of cells; or (3) selecting a cell with a longest TTT timer value among one or more cells with running TTT timers.

In some implementations, process 500 may also involve processor 322 receiving, via transceiver 326, an event-driven measurement report from apparatus 310 while waiting for a handover response from the target BS. Additionally, process 500 may involve processor 322 performing either of the following: (1) ignoring the event-driven measurement report; or (2) accepting the target BS as derived from the event-driven measurement report.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), an uplink (UL) signaling configuration from a source base station (BS) of a wireless network;
periodically transmitting, by the processor, a UL reference signal, which are measured by the source BS, responsive to receiving the UL signaling configuration;
receiving, by the processor, a handover command from the source BS; and
performing, by the processor, a handover procedure towards a target BS responsive to receiving the handover command from the source BS.

2. The method of claim 1, wherein the UL signaling configuration comprises one or more parameters for the transmitting of the periodic UL signals, and wherein the one or more parameters comprise information about the UL reference signal, a periodicity for periodically transmitting the UL reference signal, and a duration for transmitting the periodic UL signals.

3. The method of claim 1, wherein the periodical transmitting of the UL reference signal comprises transmitting no UL reference signal responsive to a signal strength from the source BS being above a pre-configured threshold.

4. The method of claim 1, wherein the UL reference signal contains a unique identifier (ID) for the UE within a serving cell of the UE such that each of a plurality of UEs within the serving cell is respectively associated with a unique ID different from that of another UE of the plurality of UEs.

5. The method of claim 4, wherein the periodically transmitting of the UL reference signal comprises transmitting the UL reference signal in time-frequency resources and using orthogonal codes that are different from those associated with another UE of the plurality of UEs.

6. The method of claim 1, further comprising:
prior to the receiving of the handover command, receiving, by the processor, a downlink (DL) measurement report configuration from the source BS; and
responsive to receiving the DL measurement report configuration, performing, by the processor, operations comprising:
performing DL measurements; and
periodically transmitting to the source BS a DL measurement report indicating a results of the DL measurements.

7. The method of claim 6, wherein the DL measurement report configuration comprises one or more parameters for the DL measurement, and wherein the one or more parameters comprise a reporting object, a periodicity for periodically transmitting the measurement report, and a duration for performing the DL measurement.

8. The method of claim 6, wherein the DL measurement report comprises an identification of a best cell and a reference signal received power (RSRP) of a serving cell and a best neighbor cell.

9. The method of claim 6, wherein a periodicity for periodically transmitting the UL reference signal and a periodicity for periodically transmitting the measurement report are different.

10. The method of claim 1, further comprising:
stopping, by the processor, a time-to-trigger (TTT) timer responsive to receiving the handover command.

11. The method of claim 1, further comprising:
performing, by the processor, radio resource control (RRC) reestablishment,
wherein the handover procedure is triggered by a failure of uplink measurement.

12. A method, comprising:
transmitting, by a processor of a source base station (BS), an uplink (UL) signaling configuration to a user equipment (UE) of a wireless network;
measuring, by the processor, a UL reference signal periodically transmitted by the UE;
determining, by the processor, to trigger a handover procedure to hand over the UE to a target BS based at least in part on a result of the measuring; and
transmitting, by the processor, a handover command to the UE.

13. The method of claim 12, further comprising:
prior to determining to trigger the handover procedure, transmitting, by the processor, a downlink (DL) measurement report configuration to the UE; and
periodically receiving, by the processor, a DL measurement report from the UE; and
performing configuration or reconfiguration of measurement reporting responsive to occurrence of either or both of a plurality of conditions comprising:
an uplink signal strength, represented by a reference signal received power (RSRP) or a reference signal received quality (RSRQ), falling below a pre-configured threshold; and
the uplink signal strength dropping faster than a pre-configured rate for a predetermined duration.

14. The method in claim 13, where the DL measurement report configuration comprises:
a content indicating about which and how many cells the UE is to report, a measurement consolidation method, and a cell quality indicator;
a reporting interval between two consecutive transmissions of the DL measurement report; and
a reporting duration represented by a period of time during which the UE is to periodically transmit the DL measurement report or a predetermined number of periodic transmissions of the DL measurement report.

15. The method in claim 13, further comprising:
adjusting, by the processor, the DL measurement report configuration based on a result of the measuring of the UL reference signal periodically transmitted by the UE responsive to a signal strength of the UL reference signal falling below a threshold.

16. The method of claim 12, further comprising:
prior to transmitting the handover command to the UE, determining, by the processor, a need to trigger the handover procedure while no event-driven measurement report has been received; and
transmitting, by the processor, a handover request to a target BS.

17. The method of claim 16, further comprising:
receiving, by the processor, a negative response from the target BS regarding the handover request; and
selecting, by the processor, another target BS based on one or more measurement reports.

18. The method of claim 16, wherein the processor determines the need to trigger the handover procedure responsive to either or both of:
an uplink signal strength, represented by a reference signal received power (RSRP) or a reference signal received quality (RSRQ), remaining below a first pre-configured threshold for a predetermined duration; and
the uplink signal strength falling below a second pre-configured threshold which is lower than the first pre-configured threshold.

19. The method of claim 12, further comprising:
selecting, by the processor, the target BS by:
selecting a cell with a highest reference signal received power (RSRP) or reference signal received quality (RSRQ) among a plurality of cells;
selecting a cell with a highest N-best-beam average RSRP or RSRQ among the plurality of cells; or
selecting a cell with a longest time-to-trigger (TTT) timer value among one or more cells with running TTT timers.

20. The method of claim 12, further comprising:
receiving, by the processor, an event-driven measurement report from the UE while waiting for a handover response from the target BS; and
performing either of:
ignoring the event-driven measurement report; or
accepting the target BS as derived from the event-driven measurement report.
